(19) United States
(12) Patent Application Publication
(10) Pub. No.: US 2026/0131242 A1
(43) Pub. Date: May 14, 2026

(54) CHESSBOARD INTERACTION METHOD AND APPARATUS IN VIRTUAL SCENE, DEVICE, AND STORAGE MEDIUM

(71) Applicant: Tencent Technology (Shenzhen) Company Limited, Shenzhen (CN)

(72) Inventor: Ziqi WEI, Shenzhen (CN)

(21) Appl. No.: 19/442,955

(22) Filed: Jan. 7, 2026

Related U.S. Application Data
(63) Continuation of application No. PCT/CN2024/111438, filed on Aug. 12, 2024.

(30) Foreign Application Priority Data
Oct. 20, 2023 (CN) 202311368153.7

(51) Int. Cl. A63F 13/52; A63F 13/56; A63F 13/58; A63F 13/822

(52) U.S. Cl. CPC A63F 13/52; A63F 13/56; A63F 13/58; A63F 13/822

(57) ABSTRACT

This application provides a chessboard interaction method in a virtual scene performed by an electronic device. The method includes: displaying a virtual chessboard including a plurality of squares in an interface of the virtual scene; displaying, in the squares of the virtual chessboard, at least two camps that are interacting with each other, each camp including at least one chess piece, and one square being configured for bearing one chess piece; and in a process of interaction between the at least two camps, in response to that a trigger condition of an interaction event is met: determining a target square and an interaction mode corresponding to the interaction event, and changing a status or a location of a target chess piece associated with the target square according to the interaction mode.

### CROSS-REFERENCE TO RELATED APPLICATIONS

Embodiments of this application are a continuation application of PCT Patent Application No. PCT/CN2024/111438, entitled “CHESSBOARD INTERACTION METHOD AND APPARATUS IN VIRTUAL SCENE, DEVICE, AND STORAGE MEDIUM” filed on Aug. 12, 2024, which is based on and claims priority to Chinese Patent Application No. 202311368153.7, entitled “CHESSBOARD INTERACTION METHOD AND APPARATUS IN VIRTUAL SCENE, DEVICE, AND STORAGE MEDIUM” filed on Oct. 20, 2023, all of which are incorporated by reference in their entirety.

### FIELD OF THE TECHNOLOGY

This application relates to the field of human-computer interaction technologies, and in particular, to a chessboard interaction method and apparatus in a virtual scene, a device, and a storage medium.

### BACKGROUND OF THE DISCLOSURE

A display technology based on graphics processing hardware has expanded channels for environmental perception and information acquisition. Especially, a display technology of a virtual scene can implement, based on an actual application requirement, diversified interactions between virtual objects that are controlled by users or artificial intelligence, and has various typical application scenarios, such as a virtual scene of a game in which an actual combat process between virtual avatars can be simulated.

For example, the virtual scene is chess walk. The chess walk is a game mode in which players place chess pieces for battles. However, this game mode in the related technology is mostly a chess piece-related mechanism. In a combat, chess pieces on which chess walk is performed are in a chessboard independent of each other for battling, but this type of interaction limited to the interaction between different chess pieces has a relatively monotonous interaction form.

### SUMMARY

Embodiments of this application provide a chessboard interaction method and apparatus in a virtual scene, an electronic device, a computer-readable storage medium, and a computer program product, which can enrich the interaction modes.

Technical solutions of the embodiments of this application are implemented as follows:

An embodiment of this application provides a chessboard interaction method in a virtual scene performed by an electronic device, the method including:
displaying a virtual chessboard including a plurality of squares in an interface of the virtual scene;
displaying, in the squares of the virtual chessboard, at least two camps that are interacting with each other, each camp including at least one chess piece, and one square being configured for bearing one chess piece; and
in a process of interaction between the at least two camps, in response to that a trigger condition of an interaction event is met, determining a target square and an interaction mode corresponding to the interaction event and changing a status or a location of a target chess piece associated with the target square according to the interaction mode.

An embodiment of this application provides an electronic device, including:
a memory, configured to store a computer-executable instruction or a computer program; and
a processor, configured to implement the chessboard interaction method in a virtual scene provided in embodiments of this application when executing the computer-executable instruction or the computer program stored in the memory.

An embodiment of this application provides a non-transitory computer-readable storage medium, having a computer-executable instruction or a computer program stored therein, the computer-executable instruction or the computer program being configured for: when executed by a processor, implementing the chessboard interaction method in a virtual scene provided in the embodiments of this application.

An embodiment of this application provides a computer program product, having a computer program or a computer-executable instruction stored therein, and the computer program or the computer-executable instruction, when executed by a processor, implementing the chessboard interaction method in a virtual scene provided in the embodiments of this application.

The embodiments of this application have the following beneficial effects:

By applying the embodiments of this application, in a process in which a plurality of camps are interacting with each other in a virtual chessboard, when a trigger condition of an interaction event is met, a target square and an interaction mode corresponding to the interaction event are determined, and a status or a location of a target chess piece associated with the target square is changed according to the interaction mode. In this way, in the interaction process, the interaction event is introduced to increase the uncertainty of an interactive playing method in the interaction process, and the interaction event is introduced to implement interaction between the target square and the target chess piece, so that the status or the location of the target chess piece in the virtual chessboard is changed by using the interaction mode, thereby improving the diversity of interactive playing methods and improving the utilization of hardware resources.

### BRIEF DESCRIPTION OF THE DRAWINGS

FIG. 1 is a schematic architecture diagram of a chessboard interaction system 100 in a virtual scene according to an embodiment of this application.

FIG. 2 is a schematic structural diagram of an electronic device 500 according to an embodiment of this application.

FIG. 3 is a schematic flowchart of a chessboard interaction method in a virtual scene recognized by an object according to an embodiment of this application.

FIG. 4 is a schematic display diagram of a virtual chessboard according to an embodiment of this application.

FIG. 5 is a schematic diagram of a trigger effect of an interaction event according to an embodiment of this application.

FIG. 6 is a schematic diagram of changing a location of a chess piece according to an embodiment of this application.

FIG. 7 is a schematic diagram of changing a location of a chess piece according to an embodiment of this application.

FIG. 8 is a schematic diagram of a trigger effect of an interaction event according to an embodiment of this application.

FIG. 9 is a schematic diagram of a trigger effect of an interaction event according to an embodiment of this application.

FIG. 10 is a schematic flowchart of a chessboard interaction method in a virtual scene according to an embodiment of this application.

FIG. 11 is a schematic diagram of selecting an interaction mode according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In embodiments of this application, related data (for example, an interaction level of a chess piece controlled by a user) such as user information is involved. When a specific product or technology is applied to the embodiments of this application, a user's permission or consent is required, and acquisition, use, and processing of the relevant data need to comply with the relevant laws and standards.

In the following description, the term “some embodiments” describes subsets of all possible embodiments, but “some embodiments” may be the same subset or different subsets of all the possible embodiments, and can be combined with each other without conflict.

In the following description, the terms “first/second . . . ” are merely intended to distinguish between similar objects and do not indicate a specific sequence of the objects. A specific order or sequence of the “first/second . . . ” may be interchanged if permitted, so that the embodiments of this application described herein may be implemented in a sequence other than the sequence illustrated or described herein.

Unless otherwise defined, meanings of all technical and scientific terms used in this specification are the same as those usually understood by a person skilled in the art to which this application belongs. The terms used in this specification are merely intended to describe the objectives of the embodiments of this application, but are not intended to limit this application.

Before the embodiments of this application are further described in detail, a description is made on nouns and terms in the embodiments of this application, and the nouns and terms in the embodiments of this application are applicable to the following explanations.
1) A “client” is an application that is run on a terminal to provide various services, for example, a video play client or a game client.
2) “In response to” is configured for representing a condition or a status on which an executed operation depends, and when a dependent condition or status is met, one or more executed operations may be in real time or may have a set delay; unless otherwise specifically stated, there is no limitation to the order in which the operations are performed.
3) A “virtual scene” is a virtual scene displayed (provided) by an application on a terminal. The virtual scene may be a simulated environment of a real world, or may be a semi-simulated and semi-fictional environment, or may be a completely fictional virtual environment. The virtual scene may be any one of a two-dimensional virtual scene, a 2.5-dimensional virtual scene, or a three-dimensional virtual scene. A dimension of the virtual scene is not limited in the embodiments of this application. For example, the virtual scene may include the sky, the land, the ocean, and the like. The land may include an environment element like a desert or a city, and a user may control a virtual object to move in the virtual scene.
4) “Chess walk” is a general name of a type of electronic strategy card games, integrated with elements of conventional board games and role play games, and a basic game rule thereof is that a player selects chess pieces of different types for layout and matching, and then arranges, on a virtual chessboard of the player, a camp obtained through layout and matching, to automatically fight against chess pieces in camps laid out and matched by the other players until one player wins, by which one round (or one battle) is completed. The process is repeated for multiple times until the game is over.

The embodiments of this application provide a chessboard interaction method and apparatus in a virtual scene, an electronic device, a non-transitory computer-readable storage medium, and a computer program product, which can improve the diversity of interactive playing methods. The following describes an exemplary application of an electronic device provided in the embodiments of this application. The electronic device provided in the embodiments of this application may be implemented as various types of user terminals such as a laptop computer, a tablet computer, a desktop computer, a set-top box, and a mobile device (for example, a mobile phone, a portable music player, a personal digital assistant, a dedicated messaging device, and a portable gaming device), a smartphone, a smart speaker, a smart watch, an intelligent TV set, or an in-vehicle terminal, or may be implemented as a server. Exemplary applications are described below by using examples in which the device is implemented as a terminal.

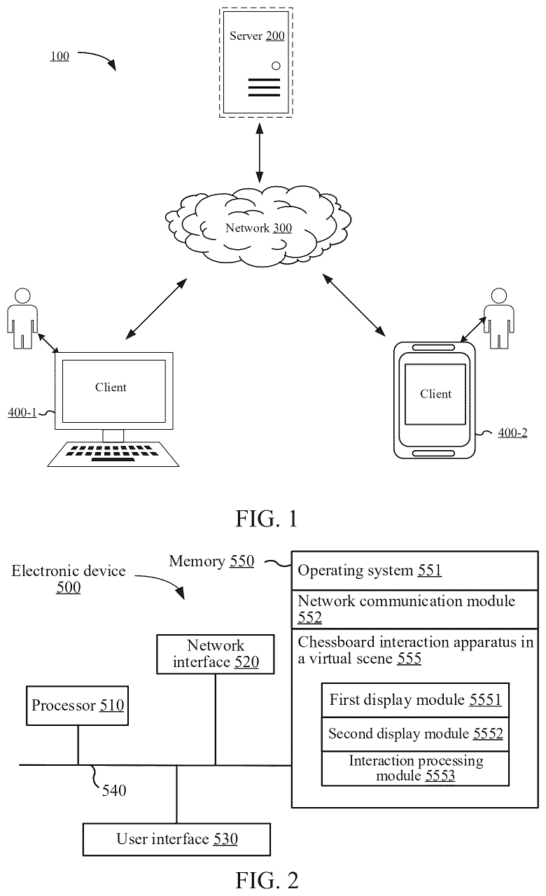

Referring to FIG. 1, FIG. 1 is a schematic architecture diagram of a chessboard interaction system 100 in a virtual scene according to an embodiment of this application. To support an exemplary application, terminals (a terminal 400-1 and a terminal 400-2 are exemplarily shown) are connected to a server 200 through a network 300. The network 300 may be a wide area network, a local area network, or a combination thereof.

In some embodiments, a client, such as a video playback client or a game client, is disposed on the terminals. The server 200 is a back-end server corresponding to the client, or may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal and the server may be connected directly or indirectly in a wired or wireless communication manner. This is not limited in the embodiments of this application.

In an actual application, the terminal displays a virtual chessboard including a plurality of squares in an interface of a virtual scene; and displays, in the squares of the virtual chessboard, at least two camps that are interacting with each other, each camp including at least one chess piece, and one square being configured for bearing one chess piece; in a process of interaction between the at least two camps, the server determines whether a trigger condition of an interaction event can be met, and when the trigger condition of the interaction event is met, determines a target square and an interaction mode corresponding to the interaction event, and returns the target square and the interaction mode corresponding to the interaction event to the terminal, to cause the terminal to change, according to the interaction mode, a status or a location of a target chess piece associated with the target square.

Referring to FIG. 2, FIG. 2 is a schematic structural diagram of an electronic device 500 according to an embodiment of this application. For example, the electronic device 500 is the terminal shown in FIG. 1. The electronic device 500 shown in FIG. 2 includes: at least one processor 510, a memory 550, at least one network interface 520, and a user interface 530. Components in the electronic device 500 are coupled together by using a bus system 540. The bus system 540 is configured to implement connection and communication between these components. In addition to a data bus, the bus system 540 further includes a power supply bus, a control bus, and a state signal bus. However, for ease of clear description, all types of buses are marked as the bus system 540 in FIG. 2.

The processor 510 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any conventional processor.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in the embodiments of this application is to include any other suitable type of memories. In some embodiments, the memory 550 includes one or more storage devices physically away from the processor 510.

In some embodiments, the memory 550 can store data to support various operations. Examples of the data include a program, a module, and a data structure, or a subset or a superset thereof, which are exemplarily described below.

An operating system 551 includes a system program configured to process various basic system services and perform hardware-related tasks, for example, a frame layer, a core library layer, and a driver layer, and the operating system is configured to implement various basic services and process hardware-based tasks. A network communication module 552 is configured to reach another electronic device via one or more (wired or wireless) network interfaces 520. Exemplary network interfaces 520 include: Bluetooth, wireless compatibility authentication (Wi-Fi), a universal serial bus (USB), and the like.

In some embodiments, the chessboard interaction apparatus in a virtual scene provided in the embodiments of this application may be implemented by using software. The chessboard interaction apparatus in a virtual scene provided in the embodiments of this application may be provided as various software embodiments, including various forms such as an application, software, a software module, a script, or code. FIG. 2 shows a chessboard interaction apparatus 555 in a virtual scene stored in the memory 550. The apparatus may be software in a form of a program, a plug-in, or the like, and includes a series of modules, including a first display module 5551, a second display module 5552, and an interaction processing module 5553. These modules are logical modules, and therefore may be combined in different manners or further split based on implemented functions. Functions of the modules are described below.

In some other embodiments, the apparatus provided in the embodiments of this application may be implemented in a hardware manner. For example, the apparatus provided in the embodiments of this application may be a processor in the form of a hardware decoding processor. The processor is programmed to perform the chessboard interaction method in a virtual scene provided in the embodiments of this application. For example, the processor in the form of a hardware decoding processor may adopt one or more application-specific integrated circuits (ASICs), DSPs, PLDs, complex PLDs (CPLDs), field-programmable gate arrays (FPGAs), or other electronic elements.

In some embodiments, the terminal or the server may implement the chessboard interaction method in a virtual scene provided in embodiments of this application by running various computer-executable instructions or a computer program. For example, the computer-executable instruction may be a microprogram-level command, a machine instruction, or a software instruction. The computer program may be a native program or a software module in an operating system; may be a native application (APP), namely, a program that needs to be installed in an operating system to run; or may be a mini program that may be embedded in any APP, namely, a program that only needs to be downloaded into a browser environment to run. To sum up, the computer-executable instruction may be an instruction in any form, and the foregoing computer program may be an application, a module, or a plug-in in any form.

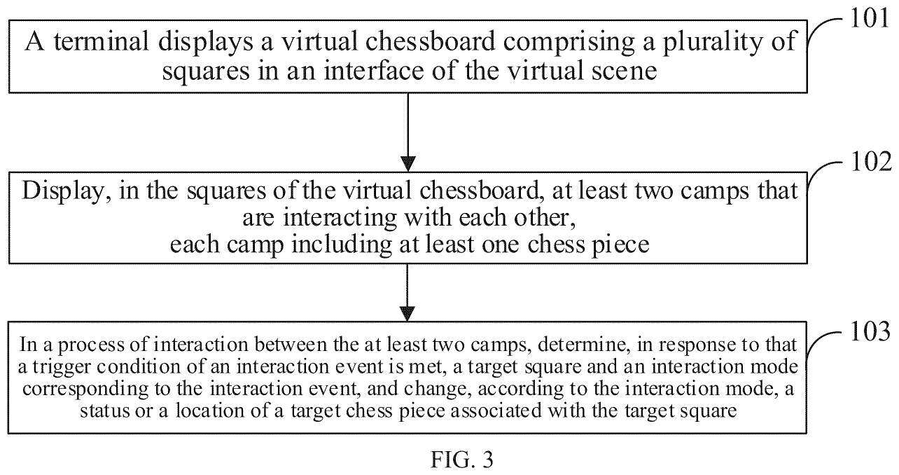

As described above, the chessboard interaction method in a virtual scene provided in the embodiments of this application may be implemented by various types of electronic devices, for example, may be implemented by any one of the terminal and the server 200 in FIG. 1 alone, or may be implemented by the terminal and the server 200 in FIG. 1 collaboratively. Subsequently, a description is provided by using an example in which the terminal in FIG. 1 alone executes the chessboard interaction method in a virtual scene provided in the embodiments of this application. Referring to FIG. 3, FIG. 3 is a schematic flowchart of a chessboard interaction method in a virtual scene according to an embodiment of this application, and operations shown in FIG. 3 are combined for description.

Operation 101: Display a virtual chessboard including a plurality of squares in an interface of the virtual scene.

In an actual application, a client supporting a virtual scene is installed on a terminal (for example, when the virtual scene is a chess walk game, a corresponding client may be a chess walk game APP). When a user opens the client installed on the terminal and the terminal runs the client, an interface of the virtual scene may be displayed on the client, and a virtual chessboard is displayed in the interface of the virtual scene. The virtual chessboard includes an interaction area and a battle preparation area, the interaction area and the battle preparation area each is formed by a plurality of squares configured for bearing chess pieces, one square is configured for bearing one chess piece, the squares in the battle preparation area are configured for bearing chess pieces that have not been put on a battle, the squares in the interaction area are configured for bearing chess piece that have been put on a battle, and a location of a square in which a chess piece is located in the interaction area affects an interaction range (for example, an attack range) and an interaction effect (for example, a combat effect) of the chess piece. At the beginning of interaction in each round (that is, each round or each game), after a player arranges his or her chess piece in a corresponding square, the chess piece can interact (for example, a combat) with a chess piece arranged by another player (that is, a chess piece in another camp).

Operation 102: Display, in the squares of the virtual chessboard, at least two camps that are interacting with each other, each camp including at least one chess piece.

Here, at the beginning of each round, a battle preparation stage is first entered. In the battle preparation stage, the player may properly select and purchase a chess piece according to his or her own camp (or formation) and strategy, where each chess piece has a unique skill mechanism and combat mechanism (that is, a chess piece is usually a virtual avatar participating in interaction in the virtual scene, different chess pieces have different skills or combat modes, and have a mutual intercepting or fighting relationship), and properly lay out the purchased chess pieces to form his or her own camp, so as to improve the win rate of the combat. After the battle preparation stage ends and a battle stage (that is, an interaction stage) is entered, the camp of the player corresponding to the current login account and camp of another player (that is, corresponding to another login account different from the current login account) can interact (or combat) in the squares of the virtual chessboard. In the interaction process, the player cannot control specific actions of the chess pieces, and the specific actions of the chess pieces are automatically calculated and determined by the system. When a player wins, gold coins and an empirical value can be obtained. The gold coins are configured for purchasing more chess pieces, and the empirical value is configured for improving the level of the player.

In addition, in the interaction process, a player may improve a combat power of a chess piece by purchasing a virtual skill and virtual equipment. Different virtual skills or different virtual equipment can bring different gain effects. For example, some virtual skills can enhance an attack power of a chess piece, and some virtual skills can enhance a defense power and a special capability of a chess piece. The player needs to continuously adjust the camp, purchase or use skill equipment to deal with different enemies. In addition, the player may alternatively team and cooperate with other players, to support and cooperate with each other in a combat.

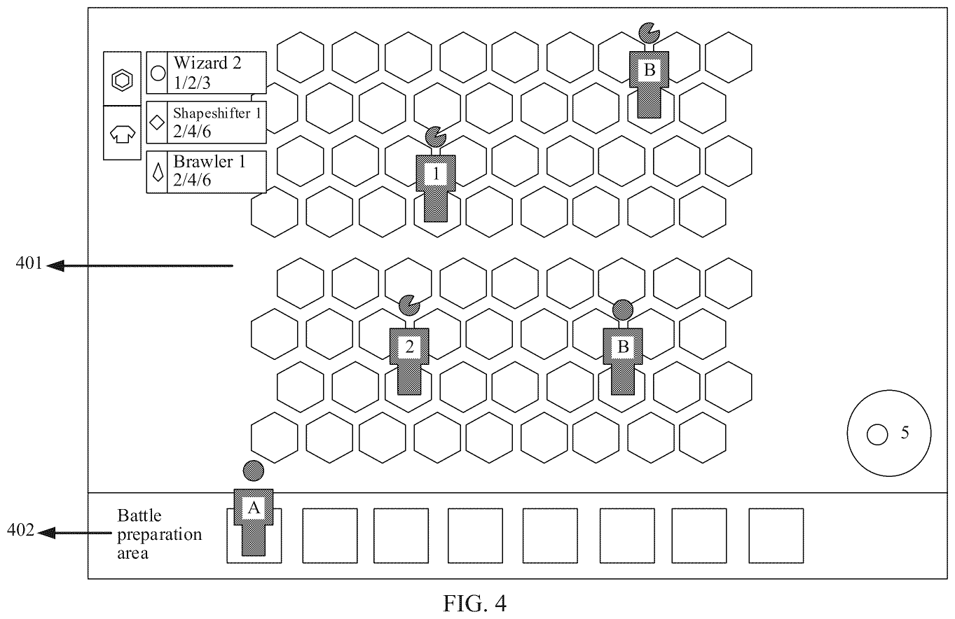

Referring to FIG. 4, FIG. 4 is a schematic display diagram of a virtual chessboard according to an embodiment of this application. A virtual chessboard is displayed in an interface of a virtual scene. The virtual chessboard includes an interaction area 401 and a battle preparation area 402. The interaction area 401 and the battle preparation area 402 each is formed by a plurality of squares for bearing chess pieces. After a player selects a needed chess piece, if the chess piece is not put in battle (that is, the chess piece is not selected for interaction), the chess piece that is not put in battle is displayed in the battle preparation area 402 on the player side, and a chess piece that is put in battle (that is, a chess piece that is selected for interaction) is displayed in the interaction area 401, that is, chess pieces in camps that participate in the interaction are displayed in the interaction area 401.

Operation 103: In a process of interaction between the at least two camps, determine, in response to that a trigger condition of an interaction event is met, a target square and an interaction mode corresponding to the interaction event, and change, according to the interaction mode, a status or a location of a target chess piece associated with the target square.

In some embodiments, before determining the target square and the interaction mode corresponding to the interaction event, the terminal may determine, in the following manner, that the trigger condition of the interaction event is met: determining, in response to that a random time point corresponding to the interaction event is reached, that the trigger condition of the interaction event is met; or determining, in response to that an interaction progress of the at least two camps reaches a first target progress, that the trigger condition of the interaction event is met; or determining, in response to that a target chess piece in the at least two camps triggers a first target event, that the trigger condition of the interaction event is met.

The interaction event refers to an event that can trigger interaction between a square and a chess piece participating in interaction in the interaction process of different camps. In actual application, one or more interaction events may be set before interaction of chess pieces in different camps or in an interaction process of chess pieces in different camps. Different interaction events correspond to different interaction modes, and different interaction events correspond to different trigger conditions. When a trigger condition of an interaction event is met, interaction between the square and the chess piece may be triggered in an interaction mode corresponding to the interaction event. Such interaction can change a status or a location of the target chess piece in the virtual chessboard.

In an actual application, to improve the uncertainty of an interactive playing method in a chess piece interaction process, a trigger occasion of an interaction event is random. A trigger condition may be configured for the interaction event in advance, so as to trigger the corresponding interaction event when the trigger condition is met. For example, a trigger random time point (for example, the N^{th} second, where N may be set according to an actual requirement, and may be set to 5 or 8, or the like) is configured for the interaction event in advance, and when the random time point is reached, the interaction event is triggered.

Alternatively, a trigger interaction progress may be configured for the interaction event in advance. When an interaction progress of camps participating in the interaction reaches a first target progress, the trigger condition of the interaction event is met (that is, the interaction event is triggered). Dimensions of the interaction progress and the first target progress are also random. The interaction progress may be randomly set or adjusted according to an actual requirement. For example, an interaction score is used as the dimension. When the interaction score of any camp participating in the interaction reaches a target score (that is, the first target progress, which may be set according to an actual requirement, for example, set to 80 points or 100 points), the interaction event is triggered. Still for example, the interaction progress is used as the dimension. When the interaction process of the camps participating in the interaction reaches a target process (that is, the first target progress, for example, 30%, 50%, or 80% of the entire interaction process), the interaction event is triggered.

In addition, the first target event for triggering may further be configured for the interaction event in advance. When the target chess piece participating in the interaction triggers the preconfigured first target event, the trigger condition of the interaction event is met (that is, the interaction event is triggered). The target chess piece may be a chess piece in any camp among the plurality of camps participating in the interaction, and a quantity of the target chess pieces may be one or more (two or more). When the quantity of the target chess pieces is more than one, the plurality of target chess pieces may be chess pieces in any one or more camps among the plurality of camps participating in the interaction. The first target event refers to an event that can trigger the interaction event, such as an event of releasing a target skill, an event of using target equipment, or an event of attacking a target object. In an actual application, the target event can be flexibly set and adjusted. For example, the first target event is the event of releasing a target skill. When the target chess piece releases the target skill, it is determined that the event of releasing the target skill (that is, the first target event) is triggered by the target chess piece. In this case, the trigger condition of the interaction event is met. For example, the first target event is the event of using target equipment, when the target chess piece performs interaction by using the target equipment (a virtual prop having an attack function), it is determined that the event of using target equipment (that is, the first target event) is triggered by the target chess piece. In this case, the trigger condition of the interaction event is met. For example, the first target event is the event of attacking a target object. When the target chess piece attacks a target object in an opponent camp (that is, a target chess piece in the opponent camp), it is determined that the event of attacking a target object (that is, the first target event) is triggered by the target chess piece. In this case, the trigger condition of the interaction event is met.

In the foregoing embodiments, the randomly set interaction event is triggered in the interaction process, so as to increase the uncertainty of the interactive playing method in the interaction process. The introduction of the interaction event implements the interaction between the target square and the target chess piece, thereby improving the diversity of interactive playing methods and the utilization of hardware resources.

In some embodiments, the terminal may determine the target square corresponding to the interaction event in the following manner: determining a square randomly selected from the virtual chessboard as the target square corresponding to the interaction event; or determining a square meeting a target condition and selected from squares in which chess pieces are carried in the virtual chessboard, as the target square corresponding to the interaction event.

Here, to further improve the uncertainty of an interactive playing method in the interaction process, the target square corresponding to the interaction event may be random. For example, a square (which may be a square carrying a chess piece or a square not carrying a chess piece) randomly selected from the virtual chessboard is used as the target square corresponding to the interaction event. Still for example, a square meeting a target condition and selected from squares in which chess pieces are carried in the virtual chessboard may be determined as the target square corresponding to the interaction event. The target condition includes at least one of the following: an interaction level of a carried chess piece reaches a target level (which may be randomly set according to an actual requirement, for example, a square in which a chess piece whose interaction level reaches the fifth level in the virtual chessboard is located is used as the target square); an interaction progress of a carried chess piece reaches a second target progress (where dimensions of the interaction progress and the second target progress are also random, and the interaction progress or the second target progress may be randomly set or adjusted according to an actual requirement; for example, the dimension may be an interaction score, an interaction progress, or the like; for example, a chess piece whose interaction score reaches 90 points is selected from the chess pieces carried in the virtual chessboard, and a square in which the selected chess piece is located is used as the target square); a carried chess piece triggers a second target event (where the second target event is an event that can respond to the interaction event, such as an event of releasing a target skill, an event of using target equipment, or an event of attacking a target object; in actual application, the second target event may be flexibly set and adjusted; for example, a square in which the chess piece that triggers the event of releasing a target skill is located in the virtual chessboard is used as the target square).

In the foregoing embodiments, the target square corresponding to the interaction event is also random, which can further increase the uncertainty of the interactive playing method in the interaction process, thereby improving the diversity of interactive playing methods and the utilization of hardware resources.

The target square may be selected by a terminal by intelligently performing screening according to a preset selection mechanism, or a selection entry of a square may be provided for a player, and a square selected by using the selection entry is used as the target square. For example, in response to that the trigger condition of the interaction event is met, the terminal first displays prompt information of the interaction event and a selection control (used as the selection entry) configured for selecting a square, and in response to a selection operation triggered based on the selection control, uses the selected square as the target square. In this way, the player can select the corresponding square according to an actual requirement, so as to change the status or the location of the chess piece associated with the square, thereby improving the activity of the player for the playing method.

In some embodiments, before changing, according to the interaction mode, the status or the location of the target chess piece associated with the target square, the terminal may determine the target chess piece in the following manner: determining a chess piece carried in the target square as the target chess piece associated with the target square; or determining a chess piece whose relative location to the target square is a target orientation as the target chess piece associated with the target square.

In an actual application, after the target square is determined, if the target square carries a chess piece, the chess piece carried in the target square may be used as the target chess piece associated with the target square. Alternatively, no matter whether the target square carries a chess piece, a chess piece whose relative location to the target square is a target orientation (including a factor of at least one of a distance and an angle) (that is, a chess piece carried in another square whose relative location to the target square is the target orientation) may be used as the target chess piece associated with the target square. For example, a chess piece carried in a square right before the target square may be used as the target chess piece associated with the target square, or a chess piece carried in a square other than the two squares to the right of the target square may be used as the target chess piece associated with the target square, and so on. In this way, the target chess piece may similarly be random, which can further increase the uncertainty of interactive playing method in the interaction process, thereby improving the diversity of interactive playing methods and the utilization of hardware resources.

In some embodiments, the terminal may change the status or the location of the target chess piece associated with the target square according to the interaction mode in the following manner: changing a movement status or an attribute status of the target chess piece associated with the target square when the interaction mode instructs to change a status of a chess piece in the virtual chessboard; and changing a location of the target chess piece associated with the target square in the virtual chessboard when the interaction mode instructs to change a location of a chess piece in the virtual chessboard.

Here, when the interaction mode instructs to change the status of the chess piece in the virtual chessboard, the movement status of the target chess piece associated with the target square may be changed in the interaction mode (that is, whether the target chess piece moves or a moving form of the target chess piece is changed), for example, changed from a moving state to a static state, or changed from a running state to a jumping state, or the like; or the attribute status of the target chess piece is changed in the interaction mode; after the attribute status is changed, an interaction capability of the target chess piece is affected, and interaction is performed based on a new attribute status or interaction capability, which increases the uncertainty of the interaction of the chess piece in the virtual chessboard, and improves the challenge and interest of the interaction.

When the interaction mode instructs to change the location of the chess piece in the virtual chessboard, the location of a target chess piece associated with the target square in the virtual chessboard may be changed by using the interaction mode. For example, the square in which the target chess piece is located is changed from a first square to a second square. After the location is exchanged, the target chess piece in a new location needs to re-lock an attack target, that is, after the location is changed, the target chess piece needs to re-lock the chess piece in the attack interaction according to a new distance and position. In this way, the randomness of the interaction between different camps in an interaction process is increased, and the challenge and interest of the interaction are improved.

In some embodiments, before changing the movement status of the target chess piece associated with the target square, the terminal may first control the target chess piece associated with the target square to move in the virtual chessboard. Correspondingly, the terminal may change the movement status of the target chess piece associated with the target square in the following manner: controlling the target chess piece to change from a moving state to a frozen state, where the target chess piece in the frozen state is in a static state in the virtual chessboard.

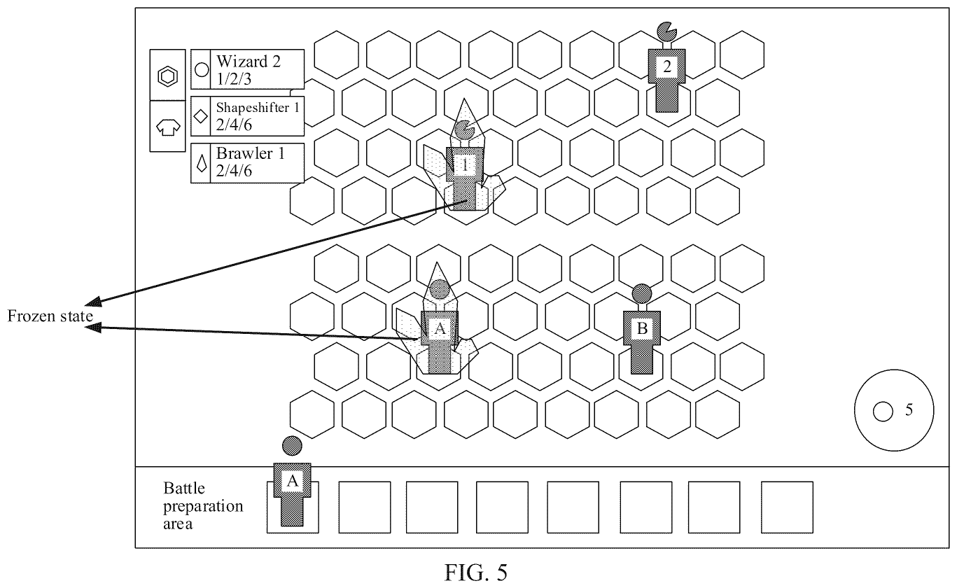

Referring to FIG. 5, FIG. 5 is a schematic diagram of a trigger effect of an interaction event according to an embodiment of this application. When the interaction event is an event having a function of freezing a chess piece, the interaction mode corresponding to the interaction event is a freezing mode. Before the trigger condition of the interaction event is met, the target chess piece may move in different squares in the virtual chessboard. When the trigger condition of the interaction event is met, the target chess piece is frozen in the interaction mode (that is, the freezing mode) corresponding to the interaction event, to prohibit the target chess piece from moving in the virtual chessboard, that is, the target chess piece is controlled to be changed from a moving state into a frozen state or a static state.

In the foregoing manner, after the movement status of the target chess piece associated with the target square is changed, interaction properties of the target chess piece in different movement statuses are different, leading to uncertainty in interaction with other chess pieces. In this way, the randomness of the interaction in the interaction process is increased, and the challenge and interest of the interaction are improved.

In some embodiments, in a process in which the target chess piece is in the frozen state, the target chess piece is prohibited from attacking another chess piece (that is, any other chess piece in the virtual chessboard other than the target chess piece), or another chess piece is prohibited from attacking the target chess piece. Here, when the target chess piece is in the frozen state, the target chess piece cannot attack another chess piece, or cannot be attacked by another chess piece. Certainly, in an actual application, if another chess piece is allowed to attack the target chess piece in the frozen state, when the target chess piece in the frozen state is attacked by another chess piece, a linkage effect may further be triggered. For example, another chess piece attacking the target chess piece is additionally hurt by re-bounce by the target chess piece (or an ice block configured for freezing the target chess piece). In this way, ecological balance of a game can be maintained.

In some embodiments, in a process in which the target chess piece is in the frozen state, freezing duration for which the target chess piece is in the frozen state may further be obtained; and when the freezing duration reaches a target duration, the target chess piece is controlled to restore to the moving state from the frozen state.

In an actual application, after the interaction event is triggered, the change in the status of the target chess piece caused by the interaction event has time validity, that is, within an effective time range, the interaction event may cause a change in the status of the target square, and beyond the effective time range, the interaction event cannot cause a change in the status of the target square. In this case, the target chess piece is controlled to be restored from the changed state to the state before the change. For example, the target chess piece is controlled to be changed from the frozen state to an unfrozen state, and the unfrozen target chess piece may continue to move in the virtual chessboard, that is, be restored from the static state during freezing to the unfrozen moving state. This not only helps to maintain the ecological balance of the game, but also enriches the interaction modes, thereby improving the enthusiasm of a player for triggering an interaction event, and further improving the retention rate of a game product.

In some embodiments, a type of the attribute status includes at least one of the following: life value, defense power, attack power, physical power, and magic power, each type of the attribute status is represented in a form of at least one of a quantized value and a quantized graph of the corresponding state. Correspondingly, the terminal may change the attribute status of the target chess piece associated with the target square in the following manner: changing the attribute status of the target chess piece associated with the target square according to an attribute value change amount of the attribute status.

Here, changing the attribute status of the target chess piece is actually changing the attribute value of the attribute status, for example, increasing or decreasing the attribute value of the attribute status according to the attribute value change amount. When the attribute status of the target chess piece is changed, a type of attribute status of the target chess piece may be changed, or attribute statuses of a plurality of types of the target chess piece may be changed.

In an actual application, the attribute value change amount of the attribute status may be determined in the following manner. For example, an influence factor configured for influencing the attribute value change amount of the attribute status is first obtained, and then an attribute value change amount corresponding to the attribute status in positive correlation with the influence factor is determined. The influence factor includes at least one of the following: a degree of contribution of the attribute status to an interaction capability of the target chess piece and an attribute value difference between the target chess piece and another chess piece in an opponent camp that has attribute status. Usually, the attribute value change amount of the attribute status has a positive correlation with the influence factor. For example, when the influence factor includes a degree of contribution of the attribute status to the interaction capability of the target chess piece, a larger degree of contribution of the attribute status to the interaction capability indicates a larger corresponding influence factor of the attribute status, and indicates a larger corresponding attribute value change amount of the attribute status. For example, for two attribute statuses:
life value and endurance, if the degree of contribution of the life value to the interaction capability of the target chess piece accounts for 20% and the degree of contribution of the endurance to the interaction capability of the target chess piece accounts for 5%, a life value change amount is greater than an endurance value change amount. For example, the life value change amount may be 50, and the endurance value change amount may be 10.

Still for example, when the influence factor includes an attribute value difference between the target chess piece and another chess piece in an opponent camp having the attribute status, a larger attribute value difference between the target chess piece and the other chess piece in the opponent camp having the same attribute status indicates a larger attribute value change amount in the corresponding attribute status. For example, for the attribute status of life value, if the life value of the target chess piece is 100 and the life value of another chess piece in the opponent camps is 200, the life value difference between the target chess piece and the another chess piece is 100 (that is, 200-100), the life value of the target chess piece may be increased, and the life value change amount of the target chess piece is set to 80, that is, the life value of the target chess piece is increased to 180. The difference between the life value (180) of the target chess piece and the life value (200) of the other chess piece after addition changes to 20, so that the difference with the life value of the other chess piece in the opponent camp is shortened. For the attribute status of endurance, if the endurance value of the target chess piece is 100 and the endurance value of another chess piece in the opponent camp is 150, the endurance value difference between the target chess piece and the other chess piece is 50 (that is, 150-100). Due to that the endurance value difference is less than the life value difference, an increase amplitude of the endurance value of the target chess piece is less than an increase amplitude of the life value. For example, if the endurance value of the target chess piece is increased by 50, the endurance value of the target chess piece after the increase is 150 and the difference between the endurance value (150) of the target chess piece and the endurance value (150) of the other chess piece after the increase changes to 0, so that the difference between the target chess piece and the endurance value of the other chess piece in the opponent camp is shortened. In this way, the difference between interaction capabilities of different chess pieces can be shortened as much as possible, thereby facilitating maintaining of the ecological balance of the game.

In some embodiments, the terminal may change the location of the target chess piece associated with the target square in the virtual chessboard in the following manner: exchanging, when there are a plurality of target chess pieces associated with the target square, locations of the plurality of target chess pieces in the virtual chessboard.

In an actual application, when there is one target chess piece associated with the target square, changing the location of the target chess piece in the virtual chessboard may be momentarily moving the target chess piece from the square in which the target chess piece is moved to another square, so as to implement an instantaneous transfer change of a spatial location. Certainly, in an actual application, a process in which the target chess piece is gradually moved from the square in which the target chess piece is moved to another square may also be presented, so as to meet a display requirement on content diversity. The manner of changing the location of the target chess piece is not limited in the embodiments of this application. When there are a plurality of (two or more) target chess pieces associated with the target square, the locations of the multiple target chess pieces in the virtual chessboard may be changed by exchanging squares of each other in the virtual chessboard.

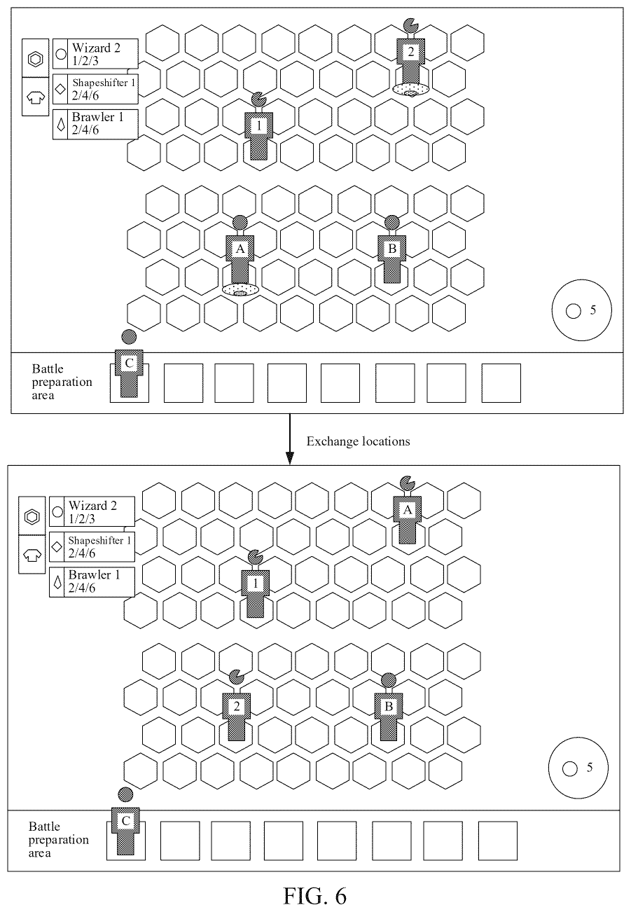

Referring to FIG. 6, FIG. 6 is a schematic diagram of changing a location of a chess piece according to an embodiment of this application. For example, the target chess pieces include a chess piece A and a chess piece 2. Before the location exchange, the chess piece A is located in a first square, and the chess piece 2 is located in a second square. When a trigger condition of an interaction event for triggering location exchange is met, the chess piece A and the chess piece 2 are controlled to exchange locations in the virtual chessboard, that is, after the location exchange, the chess piece A is located in the second square, and the chess piece 2 is located in the first square.

Different target chess pieces that exchange locations may be located in a same camp, or may be located in different camps. That is, the exchange of locations may be exchange of locations between different chess pieces in a same camp, or may be exchange of locations between different chess pieces in different camps.

In some embodiments, the terminal may change the location of the target chess piece associated with the target square in the virtual chessboard in the following manner: exchanging, when the target chess piece associated with the target square includes chess pieces in at least one chess piece pair and each of the chess piece pairs includes a first chess piece and a second chess piece pertaining to different camps, locations of the first chess piece and the second chess piece in each of the chess piece pairs in the virtual chessboard.

In an actual application, when the target chess pieces associated with the target square are different chess pieces (there are a plurality of target chess pieces) among one or more (two or more) chess piece pairs, the locations of the target chess pieces in the virtual chessboard are changed by exchanging the locations of the different chess pieces in each chess piece pair in the virtual chessboard.

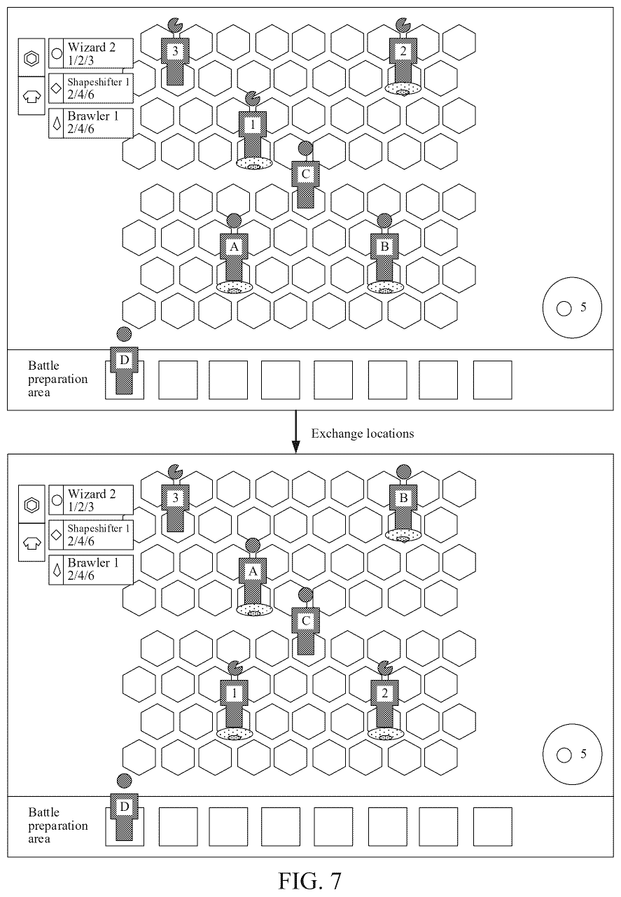

Referring to FIG. 7, FIG. 7 is a schematic diagram of changing of a location of a chess piece according to an embodiment of this application. Assuming that a first camp includes a chess piece 1, a chess piece 2, and a chess 3, a second camp includes a chess piece A, a chess piece B, and a chess piece C. If the target chess pieces include the chess piece 1 and the chess piece 2 in the first camp and the chess piece A and the chess piece C in the second camp, and (the chess piece 1 and the chess piece A) are a first chess piece pair, and (the chess piece 2 and the chess piece B) are a second chess piece pair, during location exchange, the locations (that is, the squares) of the chess piece 1 and the chess piece A in the first chess piece pair are exchanged, and the locations of the chess piece 2 and the chess piece B in the second chess piece pair in the virtual chessboard are exchanged. In this way, locations of different chess pieces in different camps are exchanged. After the location exchange, a chess piece in a new location needs to re-lock an attack target (that is, after the locations are changed, the target chess piece needs to re-lock the chess piece according to a new distance and position. In this way, the randomness of the interaction between different camps in an interaction process is increased, and the challenge and interest of the interaction are improved.

In some embodiments, the terminal may change the location of the target chess piece associated with the target square in the virtual chessboard in the following manner: controlling the target square to perform an attack operation on the target chess piece associated with the target square; and displaying a process in which the target chess piece moves from a first square to a second square in the virtual chessboard under attack of the target square.

In an actual application, when the interaction event is an event having a function of attacking a chess piece, the terminal controls the target square corresponding to the interaction event to perform an attack operation on the target chess piece, and displays a process in which the target chess piece moves from the first square to the second square in the virtual chessboard under an attack action of the target square. Before being attacked, the target chess piece is located in the first square (which may be the target square, or may be located in another square adjacent to the target square), and under the attack action, the target chess piece is attacked to move to another square, for example, the target chess piece flies after being hit by the target square and then lands to another square, or when the target chess piece is located at the rear of the target square, the target chess piece is defeated by the target square, and the like. In this way, in a process of interaction between the chess pieces of different camps, the square is controlled to truly interact with the chess piece, that is, the square is controlled to perform a truly interaction operation, and is not only configured for bearing the chess piece, thereby enriching interactive modes and improving the diversity of interactive playing methods.

In some embodiments, in the process of changing the status of the target chess piece associated with the target square, or before changing the location of the target chess piece associated with the target square, the terminal may further display a change special effect of the target square for the target chess piece.

Here, when the trigger condition of the interaction event is met, in the process of changing the status of the target chess piece in the interaction mode corresponding to the interaction event, or before the location of the target chess piece is changed, a corresponding change special effect can be presented.

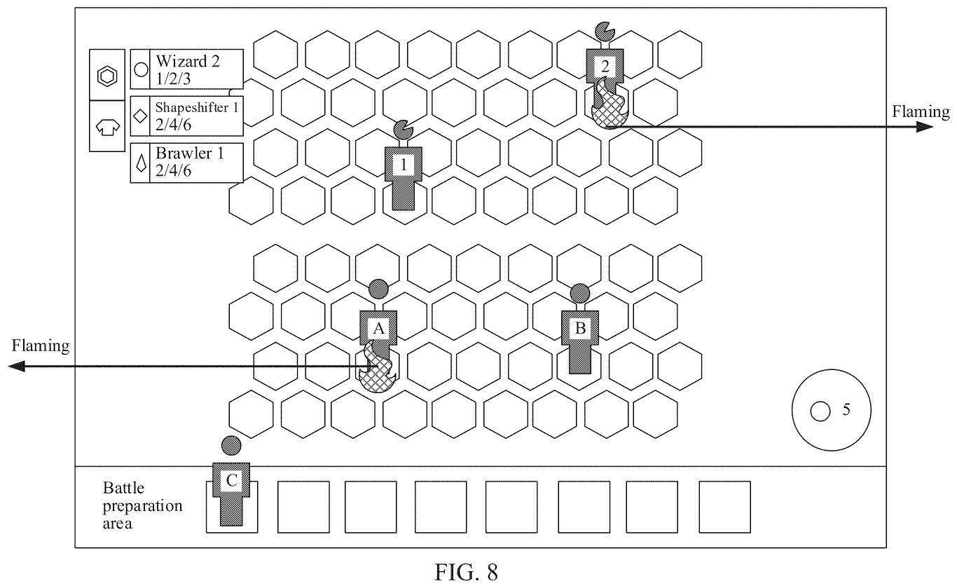

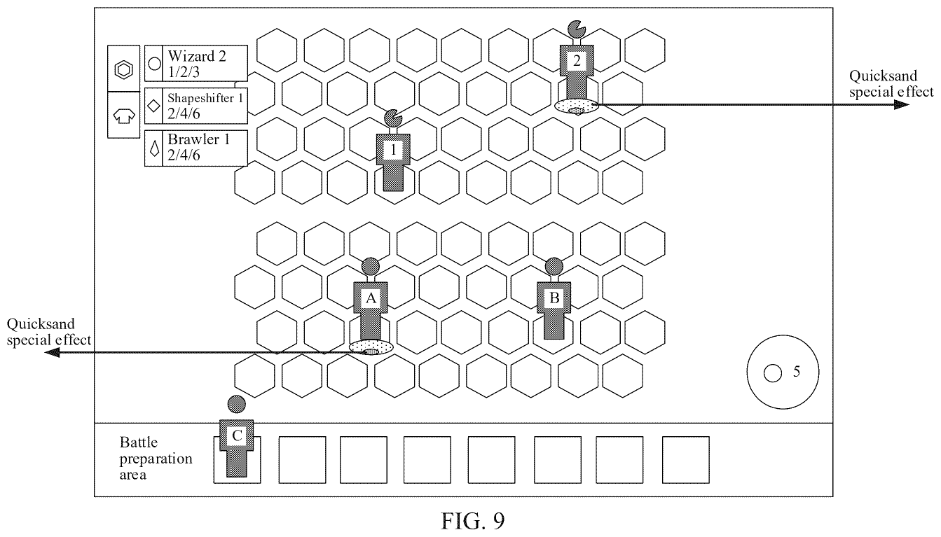

For example, when the interaction mode corresponding to the interaction event is changing the movement status of the target chess piece, for example, when the target chess piece is frozen shown in FIG. 5, a freezing special effect is displayed (for example, the chess piece is frozen by an ice block). Still for example, referring to FIG. 8 and FIG. 9, FIG. 8 and FIG. 9 are schematic diagrams of trigger effects of the interaction events according to the embodiments of this application. In FIG. 8, the interaction event is an event configured for changing a status of a target chess piece (commonly referred to as burning hill-stone). After a function event of burning hill-stone is triggered, the target chess pieces (the chess piece A and the chess piece 2) are burned and a burning special effect (such as flaming) is displayed. In a process of burning the target chess piece, the attribute status of the target chess piece changes, for example, the blood volume is reduced by 5% per second, and the blood volume is increased by 200% for damage. In FIG. 9, the interaction event is an event (commonly referred to as a quicksand zone) configured for changing the location of the target chess piece. After the function event of the quicksand zone is triggered, the target chess pieces (the chess piece A and the chess piece 2) trigger a quicksand location exchange effect, quicksand swirls appear on the feet of the target chess pieces (the chess piece A and the chess piece 2) (that is, displaying a quicksand special effect). When the quicksand swirls reach a degree or disappear, the locations of the target chess pieces in the virtual chessboard are changed, for example, the locations of the chess piece A and the chess piece 2 are exchanged.

In some embodiments, the terminal may change, according to the interaction mode, the status or the location of the target chess piece associated with the target square in the following manner: changing, when there is one interaction event and there are at least two target squares and according to the interaction mode, statuses or locations of target chess pieces respectively associated with the at least two target squares.

Here, when there is one interaction event, and there are a plurality of target squares corresponding to the interaction event, due to the fact that one interaction event corresponds to one interaction mode, statuses or locations of the target chess pieces respectively associated with the plurality of target squares may be simultaneously changed in the interaction mode.

For example, the interaction event is the foregoing quicksand zone. After the function event of the quicksand zone is triggered, assuming that the target square corresponding to the quicksand zone includes a square 1 and a square 2, the square 1 is associated with a chess piece 1 and a chess piece A, and the square 2 is associated with a chess piece 2 and a chess piece B, by using an interaction mode (that is, exchanging locations) corresponding to the quicksand zone, locations between the chess piece 1 and the chess piece A are exchanged, and locations between the chess piece 2 and the chess piece B are exchanged. In this way, one interaction event causes exchange of locations of a plurality of chess pieces, thereby improving the efficiency of the interaction and the diversity of the interaction.

In some embodiments, the terminal may change the status or the location of the target chess piece associated with the target square according to the interaction mode in the following manner: changing, when there are at least two interaction events, the at least two interaction events correspond to one target square, and one interaction event corresponds to one interaction mode and according to at least one interaction mode among the at least two interaction modes, the status or the location of the target chess piece associated with the target square.

Here, when there are a plurality of interaction events triggered at a same moment, and the plurality of interaction events correspond to a same target square, due to the fact that one interaction event corresponds to one interaction mode, the plurality of interaction events have a plurality of interaction modes. When the plurality of interaction events are simultaneously triggered, some or all of the interaction modes may be selected from the plurality of interaction modes, so as to change the status or the location of the target chess piece associated with the target square.

In some embodiments, the terminal may change the status or the location of the target chess piece associated with the target square according to at least one of the at least two interaction modes in the following manner: changing, according to an interaction mode randomly selected from the at least two interaction modes, the status or the location of the target chess piece associated with the target square; or changing, according to a target interaction mode among the at least two interaction modes, the status or the location of the target chess piece associated with the target square, where a degree of fitting between the target interaction mode and the target chess piece exceeds a degree-of-fitting threshold; or changing, according to a target quantity of interaction modes among the at least two interaction modes, the status or the location of the target chess piece associated with the target square in a superimposed manner, where a superimposed change degree of the target quantity of interaction modes for the status or the location of the target chess piece exceeds a sum of change degrees individually for the status or the location of the target chess piece in each interaction mode among the target quantity of interaction modes.

Here, when there are a plurality of interaction events triggered at a same moment, and the plurality of interaction events correspond to a same target square, one interaction mode may be randomly selected from interaction modes corresponding to the plurality of interaction events, to change the status or the location of the target chess piece associated with the target square, or according to an interaction mode of a target quantity (less than or equal to a total quantity of interaction modes) of interaction modes in at least two interaction modes, the status or the location of the target chess piece associated with the target square may be changed in a superimposed manner.

For example, there are two interaction events that are triggered at a same moment, that is, an interaction event 1 (for example, the foregoing quicksand zone) and an interaction event 2 (for example, the foregoing burning hill-stone). Both the interaction event 1 and the interaction event 2 correspond to a target square, and target chess pieces associated with the target square include a chess piece 1 and a chess piece A. Locations between the chess piece 1 and the chess piece A may be exchanged in an interaction mode (that is, location exchange) corresponding to the interaction event 1 (for example, the quicksand zone). Alternatively, the chess piece 1 and the chess piece A are burned in an interaction mode (that is, status change) corresponding to the interaction event 2 (that is, burning hill-stone), and blood volumes of the chess piece 1 and the chess piece A are reduced. Alternatively, the locations between the chess piece 1 and the chess piece A may be exchanged in the interaction mode (that is, location exchange) corresponding to the interaction event 1 (that is, the quicksand zone) while the chess piece 1 and the chess piece A are burned in the interaction mode (that is, the status change) corresponding to the interaction event 2 (that is, burning hill-stone), that is, the status and the location of the target chess piece are changed by superimposing a plurality of interaction modes. Due to the fact that the interaction event 1 and the interaction event 2 simultaneously act on the chess piece 1 and the chess piece A, a degree of change in a superimposing manner exceeds a sum of degrees of individual change for the status or the location of the target chess piece. For example, a degree of blood volume reduction of the chess piece 1 and the chess piece A caused by burning when the locations of the chess piece 1 and the chess piece A are changed in the interaction mode (that is, location exchange) corresponding to the interaction event 1 (that is, quicksand zone) is greater than a degree of blood volume reduction of the chess piece 1 and the chess piece A caused by burning when the locations of the chess piece 1 and the chess piece A are not changed in the interaction mode (that is, location exchange) corresponding to the interaction event 1. In this way, more possible interaction modes are brought about for the interaction process of chess pieces, and the diversity of interaction patterns is improved.

In addition, the terminal may further select, from the plurality of interaction modes, a target interaction mode best matching the target chess piece, and change the status or the location of the target chess piece by using the target interaction mode, for example, select, from the plurality of interaction modes according to the interaction progress of the target chess piece, an interaction mode corresponding to a status or location that is currently most expected to be changed. For example, the interaction modes include an interaction mode 1 configured for changing the location and an interaction mode 2 configured for changing the status (increasing the blood volume). The interaction progress of the target chess piece is recognized. When it is recognized that the target chess piece is currently most expected to change the location, the location of the target chess piece in the virtual chessboard is changed by using the interaction mode 1 configured for changing the location. When it is recognized that the target chess piece is currently most expected to change the status (for example, increasing the blood volume), the status of the target chess piece in the virtual chessboard is changed (that is, increasing the blood volume) by using the interaction mode 2 configured for changing the status (increasing the blood volume). In this way, the terminal intelligently selects, according to the interaction progress of the target chess piece, an interaction mode best matching the target chess piece, and changes the status or the location of the target chess piece for the selected interaction mode, thereby improving the pertinence of an interaction event for change of the target chess piece, improving the interaction experience of users, and further being capable of improving the user retention rate.

Next, an exemplary application of this embodiment of this application in an actual application scene is to be described. For example, the virtual scene is a chess walk game. An existing chess walk game mechanism is mostly a chess piece related mechanism. To enrich the original playing methods, a related technology imposes particular additional attributes or skill addition to the chess pieces. However, a current battle is still limited to a mode of holding the chess pieces in a fixed chessboard to combat, the chessboard only performs a bearing function or some squares bear particular addition (that is, buff) effect in a given condition, and there is no interactions between the chessboard and the chess pieces in any other game property, limiting more possible game fun of the chess walk. In addition, in an existing chess walk game, the players know which squares have a buff effect, and the players can only place, in a battle preparation stage, a chess piece in a square having a buff effect to trigger a corresponding addition effect. Such an interaction mode determined before a battle can be handled by the players, and a combat result can also be predicted. For example, after the battle preparation ends and the battle stage is entered, a combat is performed according to a current camping location. Due to the fact that the players cannot control specific actions of the chess pieces, the combat process is highly predictable and well-standing pertinent. Relatively, the battle process has less stimulation on the players and the game is less interesting.

Therefore, an embodiment of this application provides a chessboard interaction method in a virtual scene, aiming at adding some battle uncertainty to a game with an original established procedure by randomly triggering an interaction mode between a chessboard (or a square) and a chess piece in an interaction process (that is, a combat process), to increase the diversity and uncertainty of a playing method and enrich the fun of a chess walk battle.

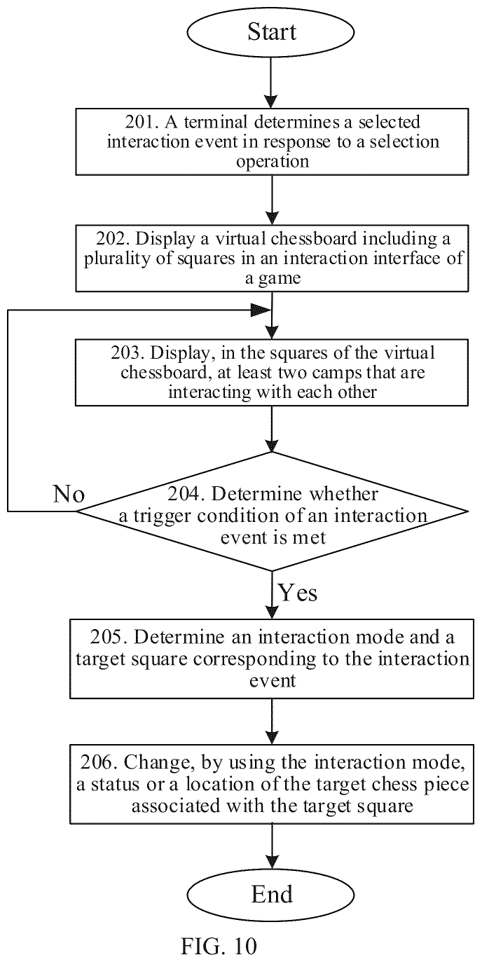

Referring to FIG. 10, FIG. 10 is a schematic flowchart of a chessboard interaction method in a virtual scene according to an embodiment of this application. The method includes:
Operation 201: A terminal determines a selected interaction event in response to a selection operation.

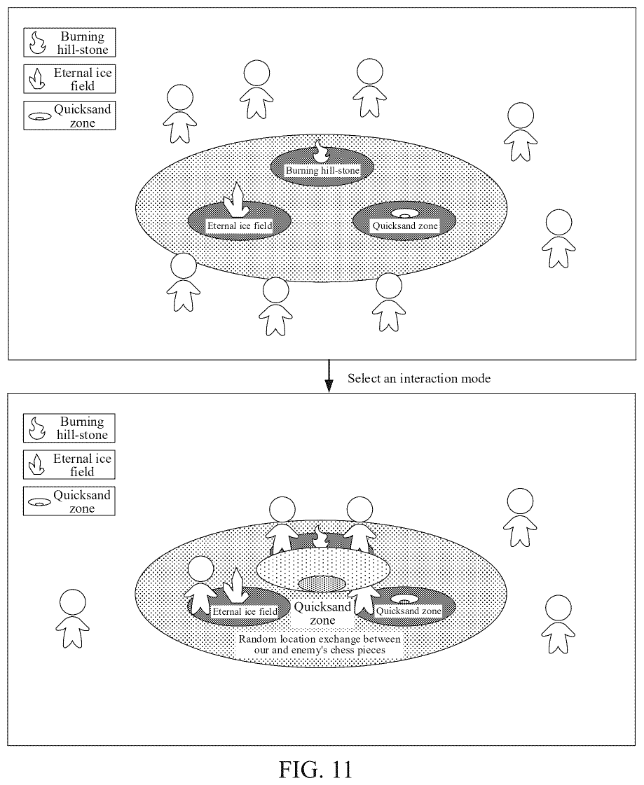

Here, before entering a battle, a player may first select an interaction event that can be randomly triggered in a game battle. Selection of the interaction event may be implemented by selecting an interaction mode. Referring to FIG. 11, FIG. 11 is a schematic diagram of selection of an interaction mode according to an embodiment of this application. Interaction modes in a plurality of styles are displayed on a selection interface, for example, burning hill-stone, eternal ice field, and quicksand zone. The player may view a function or an interaction effect corresponding to each interaction mode (that is, a corresponding interaction event may be viewed). After entering the selected interaction mode, a corresponding interaction event may be triggered in an interaction process in the entered interaction mode. For example, in the interaction mode “burning hill-stone”, an interaction event of burning a chess piece and changing an attribute status of the chess piece (for example, when the chess piece is burned, the blood volume is reduced by 5% per second, and the damage is increased by 200%) may be triggered. Still for example, in the interaction mode “eternal ice field”, an interaction event of freezing a chess piece (for example, the chess piece is converted from a moving state into a frozen state, and the chess piece in the frozen state cannot continue to move, cannot attack another chess piece, or cannot be attacked by another chess piece) can be triggered. Still for example, in the interaction mode of “quicksand zone”, an interaction event having flowing sand effect and capable of changing a location of a chess piece in the chessboard (for example, exchanging the locations between different chess pieces) can be triggered.

Operation 202: Display a virtual chessboard including a plurality of squares in an interaction interface of a game.

Here, at the beginning of each round, a player first enters a battle preparation stage. In the battle preparation stage, the player may properly select and purchase a chess piece according to his or her own camp and strategy, where each chess piece has a unique skill mechanism and combat mechanism (that is, different chess pieces have different skills or combat modes and have a mutual intercepting relationship), and properly lay out the purchased chess pieces to form his or her own camp, so as to improve the win rate of the combat.

After the player enters the battle, the terminal displays an interaction interface of the game, and displays, in the interaction interface, a virtual chessboard configured for interactive combating of chess pieces. The virtual chessboard includes an interaction area and a battle preparation area. The interaction area and the battle preparation area each is formed by a plurality of squares configured for bearing chess pieces, one square is configured for bearing one chess piece, a square in the battle preparation area is configured for bearing a chess piece that has not been put in a battle, and a square in the interaction area is configured for bearing a chess piece that has been put in a battle.

Operation 203: Display, in the squares of the virtual chessboard, at least two camps that are interacting with each other.

In a combat stage, a server randomly configures an opponent camp for the player, that is, at least two camps that are interacting with each other are displayed in a virtual chessboard. Each camp includes at least one chess piece, and the at least two camps include a camp in which the player corresponding to the current terminal is located and an opponent camp that combats with the camp in which the player is located.

Operation 204: Determine whether a trigger condition of an interaction event is met.

Here, different interaction events correspond to different trigger conditions. In an actual application, to improve the uncertainty of an interactive playing method in an interaction process, a trigger occasion of an interaction event is random. A trigger condition may be configured for the interaction event in advance, so as to trigger the corresponding interaction event when the trigger condition is met. Next, for example, a trigger random time point (for example, the N^{th} second, where N may be set according to an actual requirement, and may be set to 5 or 8, or the like) is configured for the interaction event in advance, and when the random time point is reached, the interaction event is triggered.

In the interaction process of at least two camps, whether the trigger condition of the interaction event is met may be determined in real time. For example, whether a configured random time point is reached is determined. When the trigger condition of the interaction event is met (for example, the configured random time point is reached), operation 205 is performed. Otherwise, when the trigger condition of the interaction event is not met (for example, the configured random time point is not reached), operation 203 is performed.

Operation 205: Determine an interaction mode and a target square corresponding to the interaction event.

In an actual application, different interaction events correspond to different interaction modes. Continuing the foregoing description, for the interaction event corresponding to the interaction mode “burning hill-stone”, the interaction mode corresponding to the interaction event is changing the attribute status of the chess piece (for example, burning the chess piece and reducing the blood volume of the chess piece). For the interaction event corresponding to the interaction mode “eternal ice field”, the interaction mode corresponding to the interaction event is changing the movement status of the chess piece (for example, freezing the chess piece so that the chess piece is changed from a moving state to a static state). For the interaction event corresponding to the interaction mode “quicksand zone”, the corresponding interaction mode is changing the location of the chess piece (for example, exchanging the locations of different chess pieces in the chessboard).

To further improve the uncertainty of the interactive playing method in the interaction process, the target square corresponding to the interaction event may also be random. For example, a randomly selected square (which may be a square carrying a chess piece or a square not carrying a chess piece) in the virtual chessboard is used as the target square corresponding to the interaction event.

Operation 206: Change, by using the interaction mode, a status or a location of the target chess piece associated with the target square.

To further improve the uncertainty of the interactive playing method in the interaction process, the target chess piece associated with the target square may also be random. For example, after the target square is determined, a chess piece carried in the target square may be used as the target chess piece associated with the target square, or a chess piece carried in another square whose relative location to the target square is a target orientation (including at least one factor of distance and angle) may be used as the target chess piece associated with the target square. For example, a chess piece carried in a square right before the target square may be used as the target chess piece associated with the target square, or a chess piece carried in a square other than the two squares to the right of the target square may be used as the target chess piece associated with the target square, and so on. In this way, the randomness of the target chess piece can increase the uncertainty of the interactive playing method in the interaction process, thereby improving the diversity of interactive playing methods and the utilization of hardware resources.

After the target chess piece is determined, the status or the location of the target chess piece can be changed by using the interaction mode, and a change special effect can be displayed. For example, for the interaction event corresponding to the interaction mode of “burning hill-stone”, the interaction mode corresponding to the interaction event is changing the attribute status of the chess piece, that is, the attribute status of the target chess piece can be changed by using the interaction mode, for example, the target chess piece is burned and the blood volume of the target chess piece is reduced (referring to FIG. 8). Still for example, for the interaction event corresponding to the interaction mode “eternal ice field”, the interaction mode corresponding to the interaction event is changing the movement status of the chess piece, that is, the movement status of the target chess piece can be changed by using the interaction mode, for example, the target chess piece is frozen and a freezing special effect is displayed (for example, the target chess piece is frozen into an ice block), so that the target chess piece is changed from a moving state to a static state, and the chess piece in the frozen state cannot attack another chess piece or cannot be attacked by another piece within a target time (for example, 2 seconds) (referring to FIG. 5). Still for example, for the interaction event corresponding to the interaction mode of “quicksand zone”, the corresponding interaction mode is changing the location of the chess piece, that is, the location of the target chess piece in the chessboard can be changed in the interaction mode. For example, the target chess piece includes a chess piece 1 and a chess piece A, before the location exchange, the chess piece A is located in a first square, and a chess piece 2 is located in a second square. A quicksand special effect may be displayed at the chess piece A and the chess piece 2 in the interaction mode, and locations of the chess piece A and the chess piece 2 may be controlled to be exchanged in the virtual chessboard. That is, after the location exchange, the chess piece A is located in the second square, and the chess piece 2 is located in the first square (referring to FIG. 6).

To improve the uncertainty of the interactive playing method in the interaction process, the interaction event is randomly triggered, or may be periodically triggered (for example, triggered every 10 seconds). A quantity of target squares corresponding to the interaction event may be one or more, and a quantity of target chess pieces associated with one target square may also be one or more. In this way, in a combat process, there is a random factor in each link of the interaction event, to make up for the problem that only a chessboard and a chess piece are currently known to have a buff property to interact with each other before a combat (that is, at the battle preparation stage). By means of the interaction mode between the chessboard and the chess piece, the uncertainty of the interactive playing method in the interaction process can be increased, thereby improving the diversity of interactive playing methods.

The chessboard interaction method in a virtual scene provided in the embodiments of this application is described with reference to the exemplary application and implementation of the electronic device provided in the embodiments of this application. The following further describes how the modules in the chessboard interaction apparatus 555 in a virtual scene provided in the embodiments of this application cooperate with each other to implement a chessboard interaction solution in the virtual scene.

A first display module 5551 is configured to display a virtual chessboard including a plurality of squares in an interface of the virtual scene; a second display module 5552 is configured to display, in the squares of the virtual chessboard, at least two camps that are interacting with each other, each camp including at least one chess piece, and one square being configured for bearing one chess; and an interaction processing module 5553 is configured to: in a process of interaction between the at least two camps, determine, in response to that a trigger condition of an interaction event is met, a target square and an interaction mode corresponding to the interaction event, and change, according to the interaction mode, a status or a location of a target chess piece associated with the target square.

In some embodiments, before determining the target square and the interaction mode corresponding to the interaction event, the apparatus further includes: an event triggering module, configured to determine, in response to that a random time point corresponding to the interaction event is reached, that the trigger condition of the interaction event is met; or determine, in response to that the interaction progress of the at least two camps reaches a first target progress, that the trigger condition of the interaction event is met; or determine, in response to that a target chess piece in the at least two camps triggers a first target event, that the trigger condition of the interaction event is met.

In some embodiments, the interaction processing module is further configured to determine a square randomly selected from the virtual chessboard as the target square corresponding to the interaction event; or determine a square meeting a target condition and selected from squares in which chess pieces are carried in the virtual chessboard, as the target square corresponding to the interaction event, where the target condition includes at least one of the following: an interaction level of a carried chess piece reaches a target level, an interaction progress of a carried chess piece reaches a second target progress, or a carried chess piece triggers a second target event.

In some embodiments, before changing, according to the interaction mode, the status of the target chess piece associated with the target square, the interaction processing module is further configured to determine a chess piece carried in the target square as the target chess piece associated with the target square; or determine a chess piece whose relative location to the target square is a target orientation as the target chess piece associated with the target square.

In some embodiments, the interaction processing module is further configured to change a movement status or an attribute status of the target chess piece associated with the target square when the interaction mode instructs to change a status of a chess piece in the virtual chessboard; and change a location of the target chess piece associated with the target square in the virtual chessboard when the interaction mode instructs to change a location of a chess piece in the virtual chessboard.

In some embodiments, before changing the movement status of the target chess piece associated with the target square, the apparatus further includes: a movement control module, configured to control the target chess piece associated with the target square to move in the virtual chessboard; and the interaction processing module is further configured to control the target chess piece to change from a moving state to a frozen state, where the target chess piece in the frozen state is in a static state in the virtual chessboard.

In some embodiments, the apparatus further includes: an attack processing module, configured to: forbid, in a process in which the target chess piece is in the frozen state, the target chess piece from attacking another chess piece, or forbid another chess piece from attacking the target chess piece.

In some embodiments, the interaction processing module is further configured to obtain a freezing duration for which the target chess piece is in the frozen state; and control the target chess piece to restore to the moving state from the frozen state when the freezing duration reaches a target duration.

In some embodiments, a type of the attribute status includes at least one of the following: life value, defense power, attack power, physical power, and magic power, each type of the attribute status is represented in a form of at least one of a quantized value and a quantized graph of the corresponding state. The interaction processing module is further configured to change the attribute status of the target chess piece associated with the target square according to an attribute value change amount of the attribute status.

In some embodiments, the apparatus further includes: a determining module, configured to obtain an influence factor of the attribute value change amount configured for influencing the attribute status, where the influence factor includes at least one of the following: a degree of contribution of the attribute status to an interaction capability of the target chess piece and an attribute value difference between the target chess piece and another chess piece in an opponent camp that has the attribute status; and determine an attribute value change amount corresponding to the attribute status in positive correlation with the influence factor.

In some embodiments, the interaction processing module is further configured to exchange, when there are a plurality of target chess pieces associated with the target square, locations of the plurality of target chess pieces in the virtual chessboard.

In some embodiments, the interaction processing module is further configured to exchange, when the target chess piece associated with the target square includes chess pieces in at least two chess piece pairs and each of the chess piece pairs includes a first chess piece and a second chess piece pertaining to different camps, locations of the first chess piece and the second chess piece in each of the chess piece pairs in the virtual chessboard.

In some embodiments, the interaction processing module is further configured to control the target square to perform an attack operation on the target chess piece associated with the target square; and display a process in which the target chess piece moves from a first square to a second square in the virtual chessboard under attack of the target square.

In some embodiments, the apparatus further includes: a special effect displaying module, configured to: display, in a process of changing the status of the target chess piece associated with the target square, or before changing the location of the target chess piece associated with the target square, a change special effect of the target square for the target chess piece.

In some embodiments, the interaction processing module is further configured to change, when there is one interaction event and there are at least two target squares and according to the interaction mode, statuses or locations of target chess pieces respectively associated with the at least two target squares.

In some embodiments, the interaction processing module is further configured to change, when there are at least two interaction events, the at least two interaction events correspond to one target square, and one interaction event corresponds to one interaction mode and according to at least one interaction mode among the at least two interaction modes, the status or the location of the target chess piece associated with the target square.

In some embodiments, the interaction processing module is further configured to change, according to an interaction mode randomly selected from the at least two interaction modes, the status or the location of the target chess piece associated with the target square; or change, according to a target interaction mode among the at least two interaction modes, the status or the location of the target chess piece associated with the target square, where a degree of fitting between the target interaction mode and the target chess piece exceeds a degree-of-fitting threshold; or change, according to a target quantity of interaction modes among the at least two interaction modes, the status or the location of the target chess piece associated with the target square in a superimposed manner, where a superimposed change degree of the target quantity of interaction modes for the status or the location of the target chess piece exceeds a sum of change degrees individually for the status or the location of the target chess piece in each interaction mode among the target quantity of interaction modes.

An embodiment of this application provides a computer program product, the computer program product including a computer program or a computer-executable instruction, the computer program or the computer-executable instruction being stored in a non-transitory computer-readable storage medium. A processor of an electronic device reads the computer-executable instruction from the computer-readable storage medium, and the processor executes the computer-executable instruction, to cause the electronic device to perform the chessboard interaction method in a virtual scene in the embodiments of this application.

An embodiment of this application provides a non-transitory computer-readable storage medium, having a computer-executable instruction or a computer program stored therein. When the computer-executable instruction or the computer program is executed by a processor, the processor is enabled to perform the chessboard interaction method in a virtual scene provided in the embodiments of this application, for example, the chessboard interaction method in a virtual scene shown in FIG. 3.

In some embodiments, the computer-readable storage medium may be a memory such as a ferroelectric RAM (FRAM), a ROM, a PROM, an EPROM, an EEPROM, a flash memory, a magnetic surface memory, an optical disk, or a CD-ROM, or may be any device including one of or any combination of the foregoing memories.

In some embodiments, the computer-executable instruction may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

In an example, the computer-executable instruction may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

For example, the computer-executable instruction may be deployed to be executed on one electronic device, or executed on a plurality of electronic devices located at one position, or executed on a plurality of electronic devices that are distributed in a plurality of positions and interconnected by a communication network.

The foregoing descriptions described above are merely examples of the embodiments of this application, and this is not intended to limit the protection scope of this application. Any modification, equivalent replacement, or improvement made within the spirit and scope of this application shall fall within the protection scope of this application.

What is claimed is:

1. A chessboard interaction method in a virtual scene performed by an electronic device, the method comprising:
displaying a virtual chessboard comprising a plurality of squares in an interface of the virtual scene;
displaying, in the squares of the virtual chessboard, at least two camps that are interacting with each other, each camp comprising at least one chess piece, and one square being configured for bearing one chess piece; and
in a process of interaction between the at least two camps, in response to that a trigger condition of an interaction event is met:
determining a target square and an interaction mode corresponding to the interaction event; and
changing a status or a location of a target chess piece associated with the target square according to the interaction mode.

2. The method according to claim 1, wherein before the determining a target square and an interaction mode corresponding to the interaction event, the method further comprises:
in response to that a random time point corresponding to the interaction event is reached, determining that the trigger condition of the interaction event is met;
in response to that an interaction progress of the at least two camps reaches a first target progress, determining that the trigger condition of the interaction event is met; and
in response to that a target chess piece in the at least two camps triggers a first target event, determining that the trigger condition of the interaction event is met.

3. The method according to claim 1, wherein the determining a target square corresponding to the interaction event comprises:
determining a square randomly selected from the virtual chessboard as the target square corresponding to the interaction event; or
determining a square meeting a target condition and selected from squares in which chess pieces are carried in the virtual chessboard, as the target square corresponding to the interaction event, wherein the target condition comprises at least one of the following: an interaction level of a carried chess piece reaches a target level, an interaction progress of a carried chess piece reaches a second target progress, or a carried chess piece triggers a second target event.

4. The method according to claim 1, wherein before the changing a status or a location of a target chess piece associated with the target square according to the interaction mode, the method further comprises:
determining a chess piece carried in the target square as the target chess piece associated with the target square; or
determining a chess piece whose relative location to the target square is a target orientation as the target chess piece associated with the target square.

5. The method according to claim 1, wherein the changing a status or a location of a target chess piece associated with the target square according to the interaction mode comprises:
changing a movement status or an attribute status of the target chess piece associated with the target square when the interaction mode instructs to change a status of a chess piece in the virtual chessboard; and
changing a location of the target chess piece associated with the target square in the virtual chessboard when the interaction mode instructs to change a location of a chess piece in the virtual chessboard.

6. The method according to claim 5, wherein before the changing a movement status of the target chess piece associated with the target square, the method further comprises:
controlling the target chess piece associated with the target square to move in the virtual chessboard; and
controlling the target chess piece to change from a moving state to a frozen state, wherein the target chess piece in the frozen state is in a static state in the virtual chessboard.

7. The method according to claim 1, wherein the method further comprises:
in a process of changing the status of the target chess piece associated with the target square, or before changing the location of the target chess piece associated with the target square, displaying a change special effect of the target square for the target chess piece.

8. The method according to claim 1, wherein the changing a status or a location of a target chess piece associated with the target square according to the interaction mode comprises:
when there is one interaction event and there are at least two target squares and according to the interaction mode, changing statuses or locations of target chess pieces respectively associated with the at least two target squares.

9. The method according to claim 1, wherein the changing a status or a location of a target chess piece associated with the target square according to the interaction mode comprises:
changing, when there are at least two interaction events, the at least two interaction events correspond to one target square, and one interaction event corresponds to one interaction mode and according to at least one interaction mode among the at least two interaction modes, the status or the location of the target chess piece associated with the target square.

10. An electronic device, comprising:
a memory, configured to store a computer-executable instruction or a computer program; and
a processor, configured to implement, when executing the computer-executable instruction or the computer program stored in the memory, a chessboard interaction method in a virtual scene including:
displaying a virtual chessboard comprising a plurality of squares in an interface of the virtual scene;
displaying, in the squares of the virtual chessboard, at least two camps that are interacting with each other, each camp comprising at least one chess piece, and one square being configured for bearing one chess piece; and
in a process of interaction between the at least two camps, in response to that a trigger condition of an interaction event is met:
determining a target square and an interaction mode corresponding to the interaction event; and
changing a status or a location of a target chess piece associated with the target square according to the interaction mode.

11. The electronic device according to claim 10, wherein before the determining a target square and an interaction mode corresponding to the interaction event, the method further comprises:
in response to that a random time point corresponding to the interaction event is reached, determining that the trigger condition of the interaction event is met;
in response to that an interaction progress of the at least two camps reaches a first target progress, determining that the trigger condition of the interaction event is met; and
in response to that a target chess piece in the at least two camps triggers a first target event, determining that the trigger condition of the interaction event is met.

12. The electronic device according to claim 10, wherein the determining a target square corresponding to the interaction event comprises:
determining a square randomly selected from the virtual chessboard as the target square corresponding to the interaction event; or
determining a square meeting a target condition and selected from squares in which chess pieces are carried in the virtual chessboard, as the target square corresponding to the interaction event, wherein the target condition comprises at least one of the following: an interaction level of a carried chess piece reaches a target level, an interaction progress of a carried chess piece reaches a second target progress, or a carried chess piece triggers a second target event.

13. The electronic device according to claim 10, wherein before the changing a status or a location of a target chess piece associated with the target square according to the interaction mode, the method further comprises:
determining a chess piece carried in the target square as the target chess piece associated with the target square; or
determining a chess piece whose relative location to the target square is a target orientation as the target chess piece associated with the target square.

14. The electronic device according to claim 10, wherein the changing a status or a location of a target chess piece associated with the target square according to the interaction mode comprises:
changing a movement status or an attribute status of the target chess piece associated with the target square when the interaction mode instructs to change a status of a chess piece in the virtual chessboard; and
changing a location of the target chess piece associated with the target square in the virtual chessboard when the interaction mode instructs to change a location of a chess piece in the virtual chessboard.

15. The electronic device according to claim 14, wherein before the changing a movement status of the target chess piece associated with the target square, the method further comprises:
controlling the target chess piece associated with the target square to move in the virtual chessboard; and
controlling the target chess piece to change from a moving state to a frozen state, wherein the target chess piece in the frozen state is in a static state in the virtual chessboard.

16. The electronic device according to claim 10, wherein the method further comprises:
in a process of changing the status of the target chess piece associated with the target square, or before changing the location of the target chess piece associated with the target square, displaying a change special effect of the target square for the target chess piece.

17. The electronic device according to claim 10, wherein the changing a status or a location of a target chess piece associated with the target square according to the interaction mode comprises:
when there is one interaction event and there are at least two target squares and according to the interaction mode, changing statuses or locations of target chess pieces respectively associated with the at least two target squares.

18. The electronic device according to claim 10, wherein the changing a status or a location of a target chess piece associated with the target square according to the interaction mode comprises:
changing, when there are at least two interaction events, the at least two interaction events correspond to one target square, and one interaction event corresponds to one interaction mode and according to at least one interaction mode among the at least two interaction modes, the status or the location of the target chess piece associated with the target square.

19. A non-transitory computer-readable storage medium, having a computer-executable instruction or a computer program stored therein, the computer-executable instruction or the computer program, when executed by a processor of an electronic device, causing the electronic device to implement a chessboard interaction method in a virtual scene including:
displaying a virtual chessboard comprising a plurality of squares in an interface of the virtual scene;
displaying, in the squares of the virtual chessboard, at least two camps that are interacting with each other, each camp comprising at least one chess piece, and one square being configured for bearing one chess piece; and
in a process of interaction between the at least two camps, in response to that a trigger condition of an interaction event is met:
determining a target square and an interaction mode corresponding to the interaction event; and
changing a status or a location of a target chess piece associated with the target square according to the interaction mode.

20. The non-transitory computer-readable storage medium according to claim 19, wherein before the determining a target square and an interaction mode corresponding to the interaction event, the method further comprises:
in response to that a random time point corresponding to the interaction event is reached, determining that the trigger condition of the interaction event is met;
in response to that an interaction progress of the at least two camps reaches a first target progress, determining that the trigger condition of the interaction event is met; and
in response to that a target chess piece in the at least two camps triggers a first target event, determining that the trigger condition of the interaction event is met.
